(19) United States
(12) Patent Application Publication
(10) Pub. No.: US 2017/0306982 A1
(43) Pub. Date: Oct. 26, 2017

(54) Split Casing Cavitation Generator

(71) Applicant: HST Asset Holdings LLC, Las Vegas, NV (US)

(72) Inventor: Justin McKie, Wichita Falls, TX (US)

(21) Appl. No.: 15/133,890

(22) Filed: Apr. 20, 2016

(51) Int. Cl. F04D 29/64; F04D 29/18; B01F 11/00; F04D 3/00; F04D 29/54; F04D 29/52

(52) U.S. Cl. CPC F04D 29/648; F04D 29/541; F04D 29/522; B01F 11/0077; F04D 3/005; F04D 29/181

(57) ABSTRACT

A split casing fluid device includes a reaction chamber including a first and second casings having a portions of a stator, a rotor rotatably mounted inside the stator and having a plurality of fluid-interacting features, the rotor exterior surface and the stator define a fluid passageway therebetween, an inlet into the reaction chamber in fluid communication with the fluid passageway, and an outlet from the reaction chamber in fluid communication with the fluid passageway. Removal of a casing creates an opening in the reaction chamber sized to allow passing the rotor through the opening. In some embodiments, the casings span the entire length of the rotor and removal of at least one casing creates an opening in the reaction chamber sized to allow removal of the rotor in a perpendicular direction to the longitudinal axis. The fluid device may be a cavitation generator with a rotor having cavitation-inducing features.

### FIELD

The present disclosure concerns fluid pumps and cavitation generators.

### BACKGROUND

Typical rotational fluid devices, such as pumping, mixing, and cavitation devices, operate on fluids by mechanically rotating a rotor or impeller in a reaction chamber with a stator, while a flow of fluid passes from an inlet, across the rotor or impeller, and to an outlet. Typical fluid devices comprise a one-piece reaction chamber housing with an end-cap sealing the housing or a two-piece housing split laterally to enable longitudinal separation of from piece from the other. These conventional designs enable the fluid device to be constructed or serviced by removing an end of the reaction chamber housing to access the rotor or stator in a longitudinal direction.

### SUMMARY

The concepts herein encompass using a fluid device having a reaction chamber constructed from casings split longitudinally. The present invention can also relate to pumping devices, cavitation generators, and mixers. The present invention further relates to fluid devices having a reaction chamber housing formed of multiple casings removeably coupled at longitudinal mating regions deposed along the length of the reaction chamber housing with respect to the axis of rotation. Embodiments disclosed herein provide an ability to quickly and easily service or alter the casing and impellers/rotors without the need to completely disassemble the unit. Typical multi-stage fluid device designs require the removal of the entire shaft and internals whereas the present design enables maintenance and replacement of rotor and casing parts to be conducted without disconnecting or modifying the input shaft. One skilled in the art will appreciate a substantial reduction in maintenance complexity using the present design.

In an example, a split casing fluid device includes a reaction chamber housing including a first casing having a first portion of a stator and a second casing having a second portion of the stator. The first and second casings define the reaction chamber housing. A rotor is rotatably mounted inside the stator and the rotor defines a length along a longitudinal axis of rotation. The rotor comprises an exterior surface having a plurality of fluid-interacting features, and the rotor exterior surface and the stator define a fluid passageway there between. The split casing fluid device includes a fluid inlet into the reaction chamber housing, the fluid inlet being in fluid communication with the fluid passageway, and a fluid outlet from the reaction chamber housing, the fluid outlet being in fluid communication with the fluid passageway. Removal of one or more of the casings creates an opening in the reaction chamber housing sized and shaped to allow passing the rotor through the opening.

In some examples, the rotor defines a minimum diameter, and each casing of the reaction chamber housing spans at least the length of the rotor, and at least one of the first and second casing comprises an inner surface defining a width respect to a plane normal to the longitudinal axis of the rotor greater than the minimum diameter of the rotor.

In some examples, the first and second casings defining opposing halves of the reaction chamber housing.

In some examples, the rotor comprises first and second rotor segments removeably coupled together, the first and second rotor segments each spanning the length of the rotor.

In some examples, the first and second rotor segments define opposing halves of the rotor.

In some examples, the rotor includes first and second ends each defining a cone shaped surface varying the width of the fluid passageway along the flow cone.

In some examples, the first portion of the stator is formed on an interior surface of the first casing and the second portion of the stator is formed on an interior surface of the second casing.

In some examples, the first portion of the stator is a first stator sleeve and wherein the second portion of the stator is a second stator sleeve, the first and second stator sleeves removeably nest within an inner surface of the respective first and second casings.

In some examples, the rotor defines an interior rotor volume in fluid communication with the fluid inlet, and wherein the fluid-interacting features are thru-holes between the interior rotor volume and the fluid passageway

In some examples, split casing fluid device further includes an input shaft having first and second ends, and the rotor is coupled to the input shaft and the input shaft adapted to enable rotation of the rotor in the reaction chamber housing and transfer torque to the rotor. The split casing fluid device further includes an inlet assembly including a first bearing coupled with the first end of the input shaft and an outlet assembly comprising a second bearing coupled with the second end of the input shaft.

In some examples, the first and second casings each comprise opposing first and second ends, and wherein the first ends of the first and second casings are removeably coupled to the inlet assembly, and wherein the second ends of the first and second casing are removeably coupled to the outlet assembly.

In some examples, the inlet assembly defines a first inner passageway in fluid communication with the fluid passageway and the outlet assembly defines a second inner passageway in fluid communication with the fluid passageway, the input shaft passing through the first and inner passageways. In some examples, the rotor comprises first and second rotor segments removeably coupled together, the first and second rotor segments each spanning the length of the rotor and wherein the input shaft includes an axial lock key adapted to maintain an axial location of the rotor segments on the input shaft. In some examples, the inlet assembly comprises a first external bearing assembly having the first bearing, and wherein the outlet assembly comprises a second external bearing assembly having the second bearing, and wherein the first and second external bearing assemblies position the first and second bearing outside of the first and second inner passageways.

In some examples, the split casing fluid device is a split casing cavitation generator, and wherein the plurality of fluid-interacting features comprises a plurality of cavitation-inducing features, and wherein the fluid outlet is a heated fluid outlet. In some examples, the stator comprises an inner surface defining a first plurality of apertures and wherein the plurality of cavitation-inducing features comprises a second plurality of apertures.

In some examples, the split casing fluid device is a split casing multi-stage pump, and the plurality of fluid-interacting features comprises a plurality of pumping features.

Another example is a method of servicing a split casing fluid device. The method includes, given a reaction chamber housing comprising a first casing and a second casing and a rotor rotatably mounted inside the reaction chamber housing, releasing the first casing from the second casings, and removing one of the first and second casings from the reaction chamber housing. The removing one of the first and second casings creating an opening in the reaction chamber housing sized and shaped to enable the rotor to pass though the opening. In some examples, the method further comprises passing the rotor though the opening.

A split casing fluid device is described herein. The fluid device includes a reaction chamber housing constructed of multiple casings being split longitudinally about the rotational axis of a rotor. The casings may span the length of the rotor to enable the rotor to be installed or removed in a direction perpendicular to the axis of rotation, or, in the alternative, the casings may span a sufficient portion of the length of the rotor to enable to the rotor to be removed or installed by passing through the opening created by removing on or more of the casings. In some examples, each casing may be a casing assembly constructed from multiple segments that can be individually separated as part of the process of removing the casing assembly from the reaction chamber housing. In some aspects, the reaction chamber is constructed from two casings each forming an opposing half of the reaction chamber housing. In some aspects, the reaction chamber housing is constructed from a plurality of casings joined longitudinally with respect to the axis of rotation of the rotor, with the segments having a variety of sizes, lengths, and widths.

Generally, one skilled in the art will appreciate that longitudinally joined casings enables the reaction chamber housing to be constructed around an existing rotor and shaft without modification or disconnection of the input shaft and input/output volutes. Additionally, one skilled in the art will appreciate that the split casing and rotor design described herein enables removal and replacement of the rotor without modification or disconnection of the input shaft and input/output volutes. The ability to avoid modifying the input shaft enables associated shaft features, for example, bearings and packings, to be constructed and installed without concern for routine maintenance work requiring their removal. In some instances, examples reduce complexity and improve reliability over prior art design by employing external bearing assemblies, which may be integrated with the volutes.

Some, none or all of the aforementioned examples, and examples throughout the following descriptions, can be combined.

### BRIEF DESCRIPTION OF DRAWINGS

FIG. 1 is a perspective view illustration of a split casing cavitation generator.

FIG. 2 is a perspective view illustration of the split casing cavitation generator of FIG. 1 with the top casing removed to show a rotor.

FIG. 3 is a side view illustration of a split casing cavitation generator with the reaction chamber housing removed to show a split rotor.

FIGS. 4A and 4B are perspective view illustrations of a cavitation generator with the reaction chamber housing and top-rotor segment removed.

FIG. 5 is a perspective view illustration of a split casing cavitation generator showing the interior details of the bottom casing and stator.

FIGS. 6A and 6B are side section view illustrations of a split casing cavitation generator showing the flow passageways.

FIG. 7 is perspective view illustration of a split casing cavitation generator showing the removal of a top casing.

FIG. 8 is perspective exploded view illustration of a split casing cavitation generator.

### DETAILED DESCRIPTION

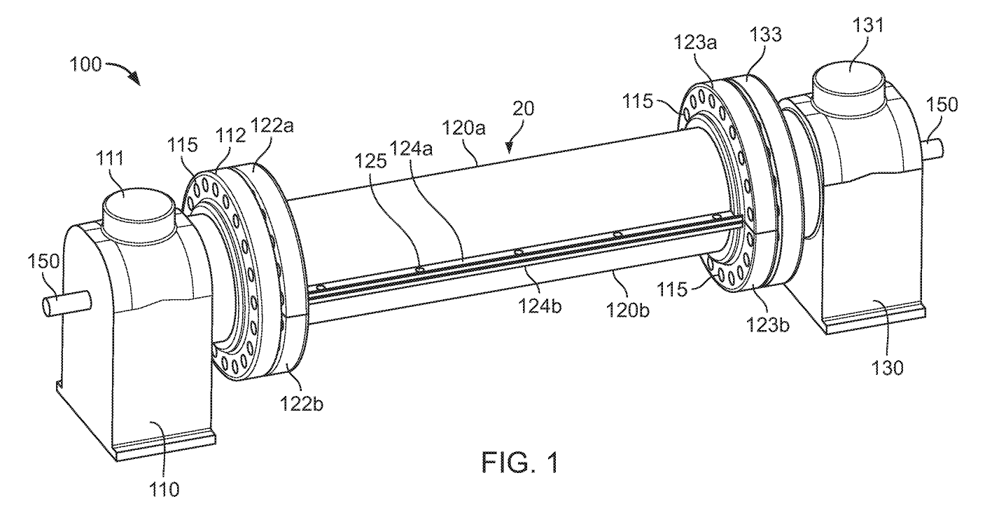

FIG. 1 is a perspective view illustration of a split casing cavitation generator. FIG. 1 shows a split casing cavitation generator 100 including an inlet volute 110, a reaction chamber housing 20, and an input shaft 150. The inlet volute 110 includes a fluid inlet 111 and an inlet flange 112. The outlet volute 130 includes a heated fluid outlet 131 and an outlet flange 133. The reaction chamber housing 20 is an assembly of two casings 120a, 120b forming opposing halves of the reaction chamber housing 20. Each casing 120a,b includes a first flange 122a,b and a second flange 123a,b. The flanges 112, 133, 122a,b, 123a,b include bolt holes 115 for joining the first flanges 122a,b to the inlet flange 112 and for joining the second flanges 123a,b to the outlet flange 123. Together, the top casing 120a and bottom casing 120b form a cylindrical reaction chamber housing 20 by being mated together along longitudinally disposed mating regions 124a,b spanning the length of the each casing 120a,b. The mating regions 124a,b include holes 125 for securing the casings 120a,b together.

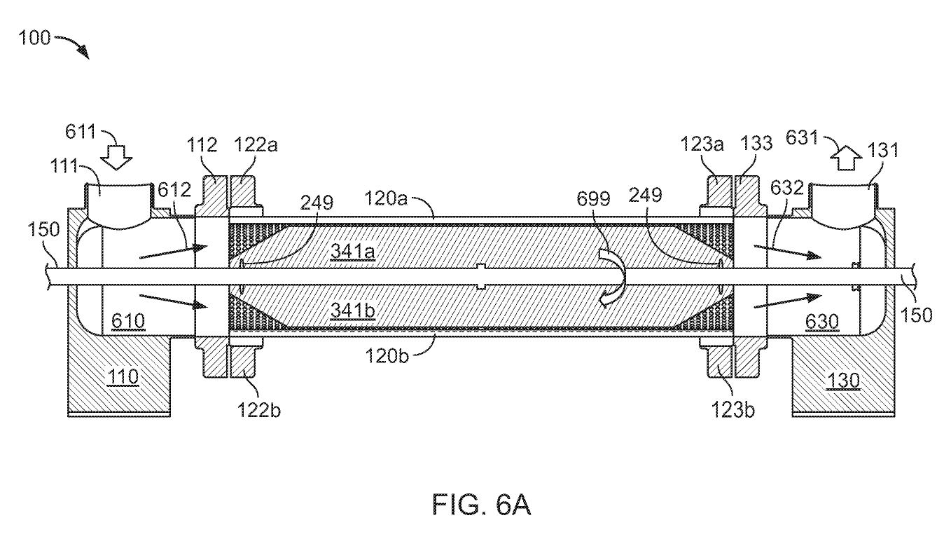

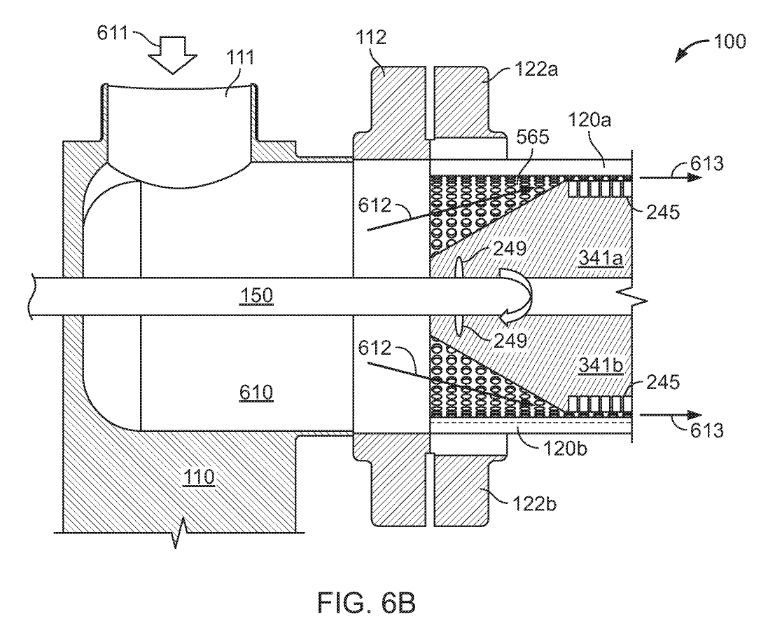

In operation, the split casing cavitation generator 100 accepts a fluid flow through the inlet 111, into the interior of the reaction chamber housing 20, and to the outlet 131. A rotor (not shown) is disposed in the reaction chamber housing 20 and is driven by the input shaft 150. The rotor is configured to spin in the reaction chamber housing as the fluid flow passes between the rotor and a stator (not shown) on the inner surface of the reaction chamber housing 20. An interaction between the rotor, stator, and fluid flow generates cavitation in the fluid flow. As shown in more detail in FIGS. 6A and 6B, the fluid flow in the reaction chamber housing interacts with the rotor (not shown) to generate cavitation in the fluid flow, and thereby increase the temperature and pressure of the fluid flow before being leaving the reaction chamber 20. The casings 120a,b being removeably connected to the inlet volute 110 and outlet volute 130 enable the access to the rotor without modification to inlet volute 110, outlet volute 130, or the input shaft 150.

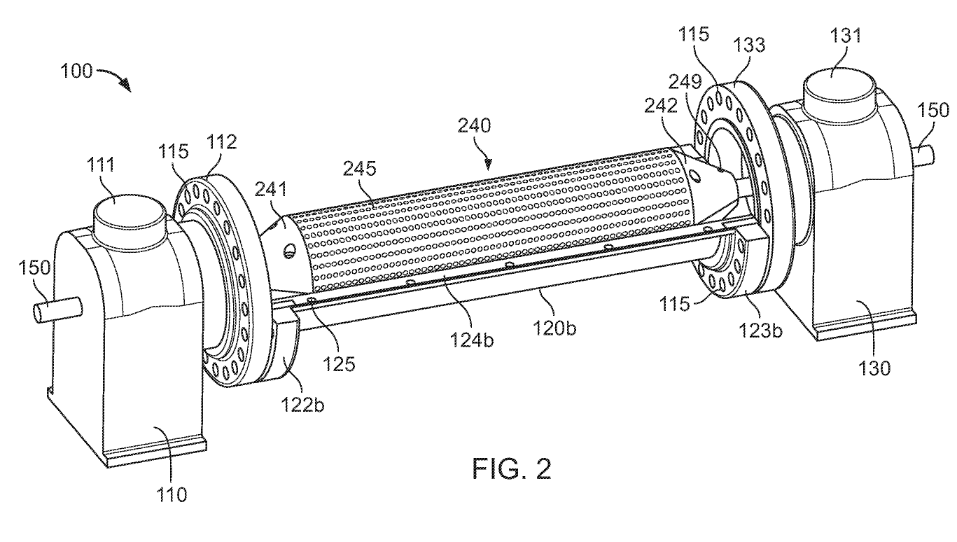

FIG. 2 is a perspective view illustration of the split casing cavitation generator of FIG. 1 with the top casing removed to show a rotor. FIG. 2 shows the split casing cavitation reaction 100 with the top casing (120a of FIG. 1) removed. FIG. 2 shows a cylindrical rotor 240 disposed on the input shaft 150 in the reaction chamber housing (20 of FIG. 1) and partially surrounded by the bottom casing 120b. The rotor 240 includes a plurality of cavitation-inducing features 245 on the exterior surface. In some instances, the cavitation-inducing features 245 are apertures, as shown in FIG. 2, dimples, or other shapes found in conventional cavitation generators. The rotor 240 also includes flow cones 241, 242 on opposite ends to direct a fluid flow from the inlet volute 110 to a fluid passageway defined between the exterior surface of the rotor 240 and the interior surface of the casings 120a,b of the reaction chamber housing 20. The rotor also includes a fastener 249 securing the rotor 240 to the input shaft 150.

In operation, removal of the top casing 120a enables access to the rotor 240 to allow for servicing and cleaning of, for example, the rotor 240 and the casings 120a,b. As shown, to remove the top casing 120a from the split casing cavitation generator 100, the first and second flanges 122a, 123a of the top casing are disconnected, respectively, from the inlet flange 112 and the outlet flange 133. Additionally, the top casing 120a is decoupled from the bottom casing 120b by removing fasteners (not shown) present in the holes 125 of the longitudinal mating regions 124a,b. FIG. 2 removal of the top casing 120a enabling access to the entire length of the rotor 240. This configuration of FIG. 2 enables both installation and removal of the rotor 240 without modification to inlet volute 110, outlet volute 130, or the input shaft 150.

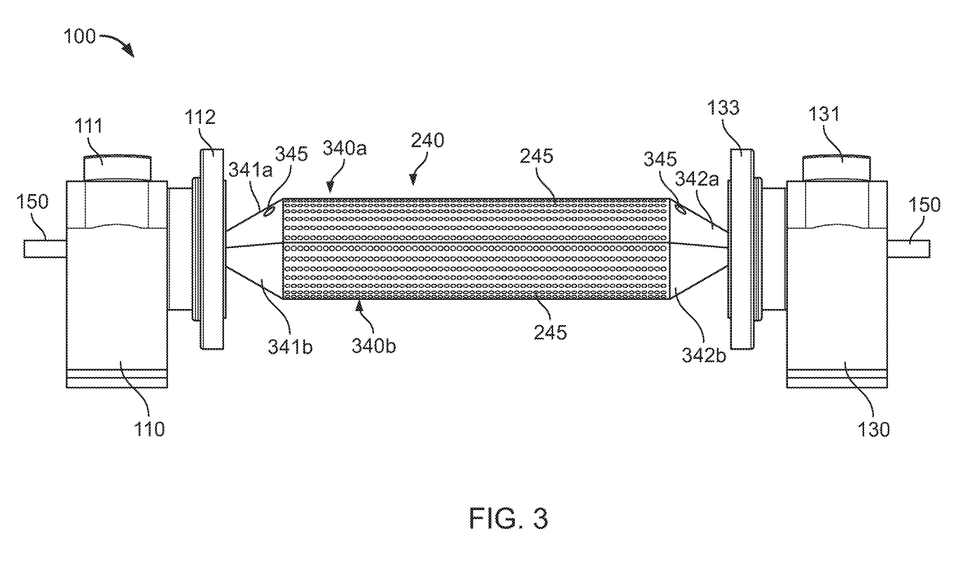

FIG. 3 is a side view illustration of a split casing cavitation generator with the reaction chamber housing removed to show a split rotor. FIG. 3 shows the split casing cavitation reactor 100 with both the top casing 120a and bottom casing 120b removed. FIG. 3 shows the rotor 240 having a two-part construction with a top rotor segment 340a and a bottom rotor segment 340b joined together around the input shaft 150 to form the rotor 240. The top rotor segment 340a is joined to the bottom rotor segment 340b by bolts (not shown) positioned in holes 345 of the top rotor segment 340a. Each rotor segment 340a,b, includes corresponding sections of the inlet and outlet flow cones 341a,b, 342a,b.

In operation, the split casing rotor 240 enables the rotor segments 340a,b, to be installed on an existing input shaft 150 and with the top casing 120b or bottom casing 120b removed.

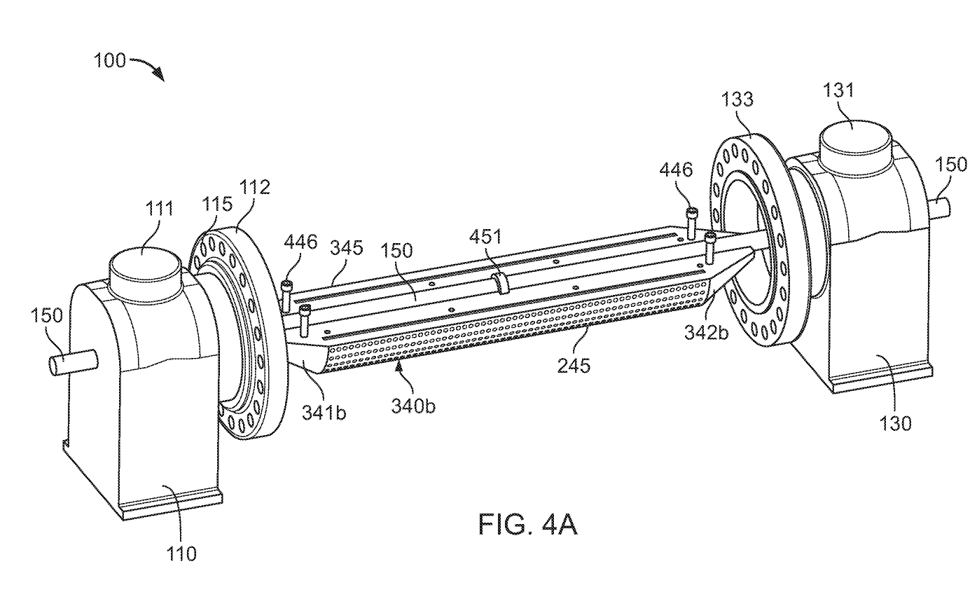

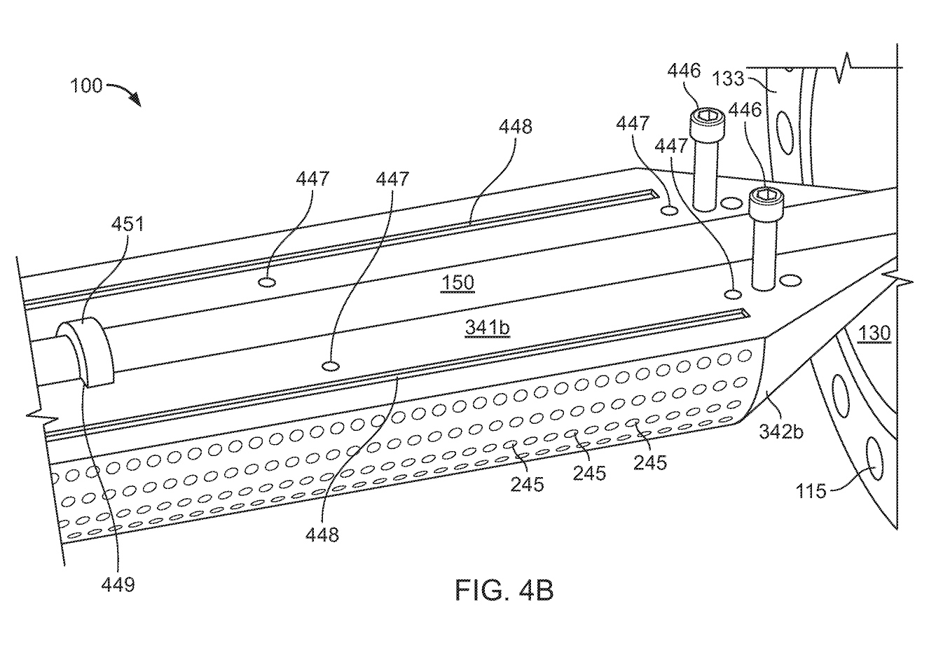

FIGS. 4A and 4B are perspective view illustrations of a cavitation generator with the reaction chamber housing and top-rotor segment removed. FIG. 4A shows the split casing cavitation reactor 100 having the top rotor segment 340a removed. The bolts 446 that are positioned in holes 345 in FIG. 3 are shown in FIG. 4A in their installed condition. FIG. 4A shows the input shaft 150 includes an axial lock key 451 configured to secure the axial position of the rotor 240 on the input shaft 150. FIG. 4B shows the details of flat the surface 449 of the bottom rotor segment 340b. The flat surface 449 is configured fit against a corresponding flat surface of the top rotor segment 340b. The flat surface 449 includes groves 448 and holes 447 configure to align the bottom rotor segment 340b with the top rotor segment 340a and prevent improper installation. Additionally, corresponding protrusions are provided on the opposing flat surface of the top rotor segment 340a (not shown) and, in some instances, are configured to interface with the grooves 448 and holes 447 on the flat surface 449 in a key-to-slot configuration.

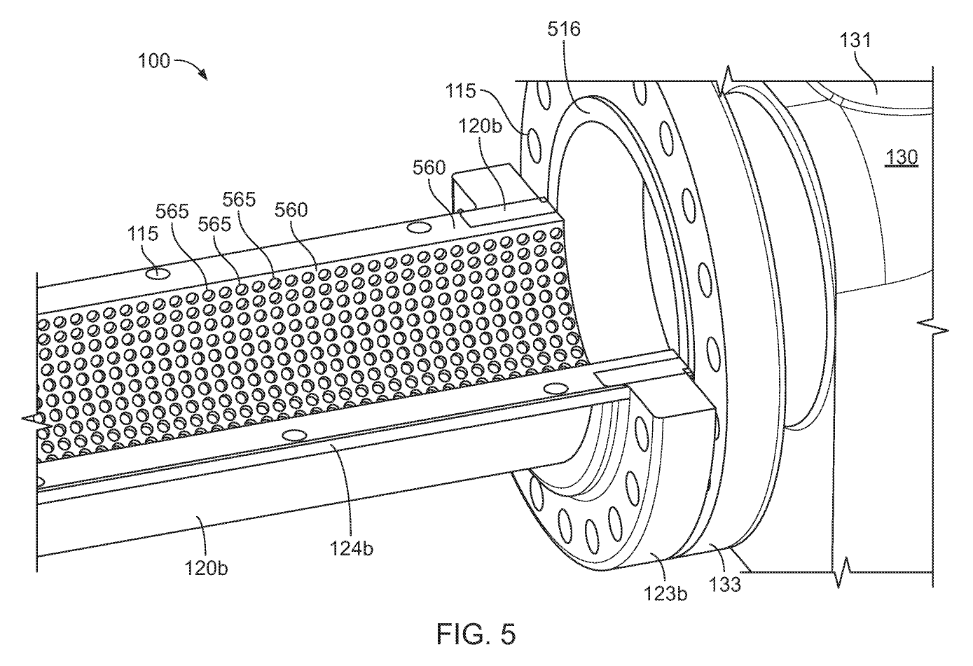

FIG. 5 is a perspective view illustration of a split casing cavitation generator showing the interior details of the bottom casing and stator. FIG. 5 shows the bottom casing 120b mated to the outlet volute 130. The outlet flange 133 of the outlet volute 130 includes a gasket seal 516 positioned to seal the connection between the outlet flange 133 and the second flanges 123a,b of the top and bottom casings 120a,b. The bottom casing 120b includes a stator 560 positioned on the inner surface of the bottom casing 120b. Though not shown, the top casing 120a includes a corresponding stator 560. The stator 560 includes a plurality of apertures 565 formed in the inner surface of the stator 560.

In some instances, the stator 560 is formed directly into the surface of the casings 120a,b, or in other instances, is, a removable sleeve nested on the inner surfaces of the casings 120a,b. A removable sleeve stator enables changing the stator 560 without replacing the casing 120a,b, which may be necessary due to wear on the surface or in order to change the radial clearance between the stator 560 and the exterior surface of the rotor 240. In some instances, changing the thickness of the stator 560 allows for different sizes of solids present in the fluid without damaging the surfaces of the stator 560 and rotor 240. Changing the thickness of the stator 560 can also be used to reduce shearing effects or to vary the velocity of the rotor 240 as a function of the fluid's properties. The stator 560 sleeve allows for simple modification of the cavitation parameters without changing the rotor 240 or reaction chamber housing 20.

FIGS. 6A and 6B are side section view illustrations of a split casing cavitation generator showing the flow passageways. FIG. 6A shows the split casing cavitation reactor 100 having a spinning 699 rotor 240 (i.e., first and second rotor segments 341a,b). The first and second rotor segments 341a,b include fasteners 249 securing the first and second rotor segments 341a,b to the input shaft 150 and transferring torque from the input shaft 150 to the first and second rotor segments 341a,b. Arrow 611 indicates a flow of fluid into the inlet volute 110 and arrow 631 indicates a flow of heated fluid from the outlet volute 630. FIG. 6B shows that the spinning first and second rotor segments 341a,b define a fluid passageway 613 between the first and second rotor segments 341a,b and the stator 560. Arrows 612 indicate the fluid flow passing along the surface of the inlet flow cone and into the fluid passageway 613.

In operation, the rotor 240 is adapted to spin 699 via the input shaft 150 and a flow of fluid 611, for example, a fluid feedstock, is provided to the inlet 111 of the inlet volute 110 of the split casing cavitation reactor 100. The inlet volute 110 defines an interior volute 610 that directs 612 the flow of fluid 611 to the reaction chamber housing 20. In the reaction chamber housing 20, the fluid 611 passes around the flow cone 341a,b and into the passage 613 between the surface of the rotor 240 and the stator 560. As the fluid between the spinning apertures 245 on the rotor 240 and the stationary aperture 565 on the stator 560, localized regions of extremely low pressure form in the fluid 611, which momentarily causes cavitation bubbles to form in the fluid 611. The subsequent and violent collapse of the cavitation bubbles generates heat within the fluid 611 from the mechanical energy of the spinning rotor 240. The intense heat and pressure of the act of cavitation is able to destroy organics that may be present in the fluid 611 along with other compounds. Through the act of hydrodynamic cavitation, and/or secondary acoustic cavitation, the fluid 611 is heated/pressurized to a degree that depends on, for a given geometry of the rotor 240 and stators 560, the mechanical energy input to the rotor 240, the fluid properties, for example, viscosity, specific heat, and heat of vaporization. Solids present in the flow small enough to pass through the fluid passageway 613 may pass unchanged.

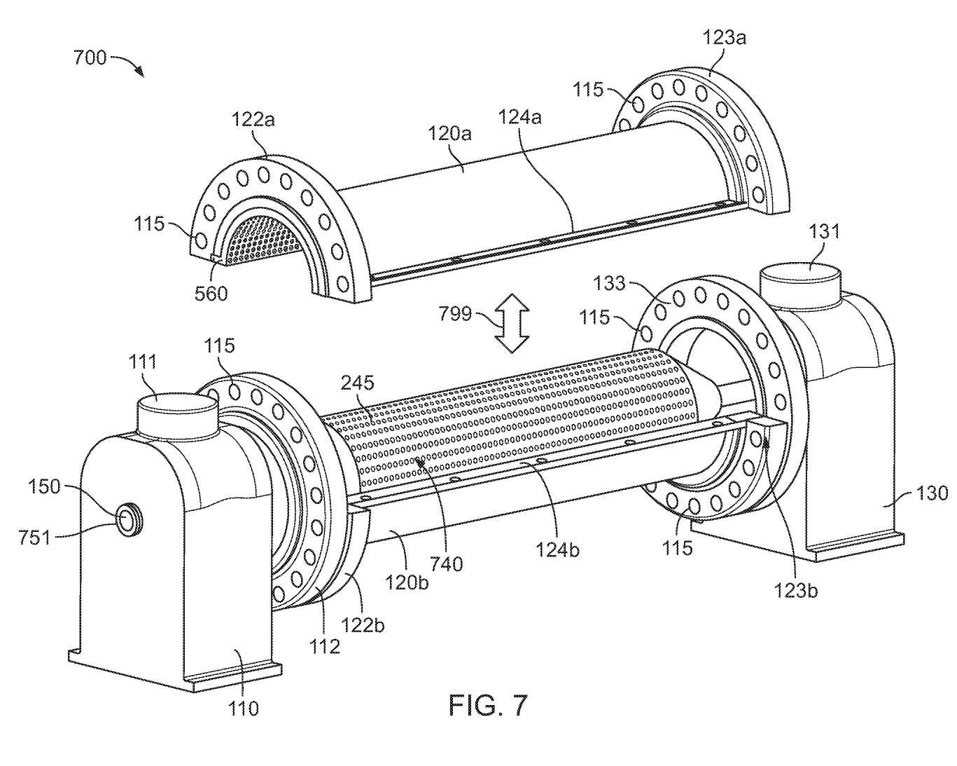

FIG. 7 is perspective view illustration of a split casing cavitation generator showing the removal of a top casing. FIG. 7 shows the top casing 120a being removed from a split casing cavitation generator 700. The top casing 120a includes a stator 560. The split casing cavitation reactor 700 includes a solid rotor 740 coupled to the input shaft 150. The input shaft is supported by a bearing 751 in the inlet volute 110 and a bearing (not shown) in the outlet volute 130. Arrow 799 indicates the direction of translation of the top casing 120a, once the top casing 120a has been disconnected from the bottom casing 120b, and the inlet and outlet flanges 112, 133. In operation, the removal of the top casing 120a provides access to the rotor 740 and to the stator of the top casing 120a. As detailed above, by enabling a user to remove the casings 120a,b, the user is provided easy access to the rotor 240 and other internals, without the need to remove bearings, volutes, shafts or other associated components. In an example operation, the rotor 240 is completely uncovered by removing the casing 120a,b, which includes disconnecting the casings 120a,b at their longitudinal mating regions 124a,b and un-bolting the casings flanges 122a,b 123a,b, from the volute flanges 112, 133, without any additional disassembly.

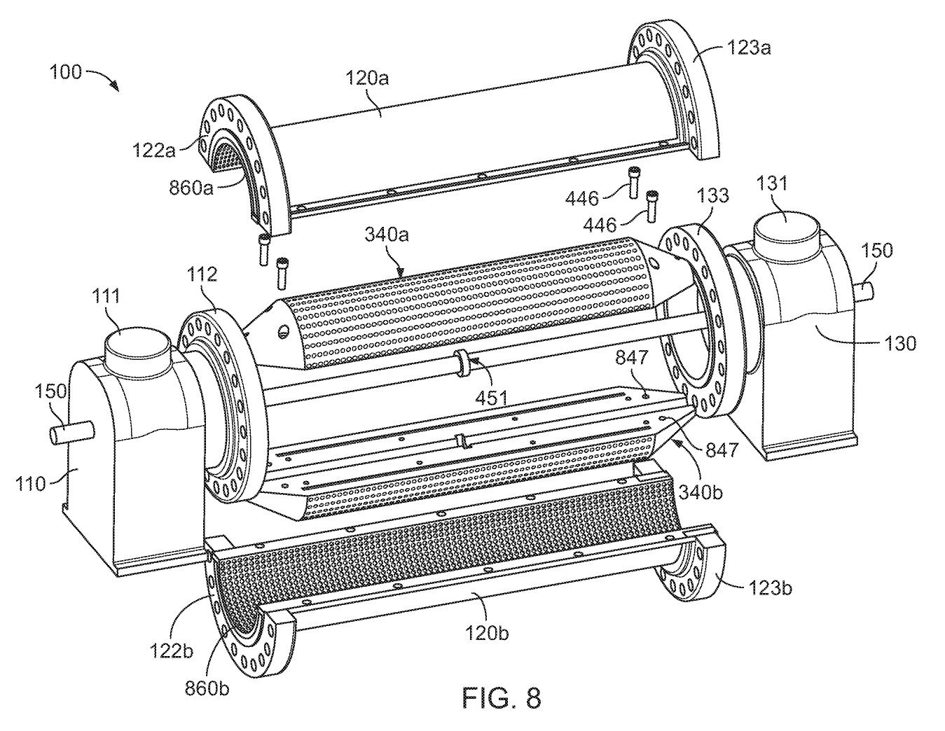

FIG. 8 is perspective exploded view illustration of a split casing cavitation generator. FIG. 8 shows the split casing cavitation generator 100 with the top and bottom casings 120a,b separated from the inlet and outlet volutes 110, 130 and with the top and bottom rotor segments 340a,b separated from the input shaft 150. Bolts 446 are shown removed from the top rotor segment 340a and the corresponding threaded holes 847 in the bottom rotor segment 340b are visible. In some instances, the bolts 446 are oriented in opposing directions to help in the balancing of the rotation of the rotor 240 by placing the center of inertia of the bolts concentric with the rotor's 240 axis of rotation. For example, a first bolt placed though the top rotor segment 340a and into the bottom rotor segment 340b and a second bolt placed in the opposite manner.

In an exemplary embodiment, the radial clearance between the exterior surface of the rotor 240 and the stator 860a,b is less than one half inch. Generally, one skilled in the art will appreciate that different clearances are necessary depending on fluid viscosity and the presence of impurities (e.g., small rocks, dirt, or debris) in the fluid.

While FIGS. 1-8 have shown the fluid device as a single-stage cavitation reactor 100, alternatively, the rotor 240 may be one of a plurality of rotors 240 in single reaction chamber housing. In other instances, the fluid device may comprise multiple reaction chamber housing linked together, with each having one or more rotors.

While FIGS. 1-8 have shown the reaction chamber housing 20 as having a cylindrical shape, alternatively, the reaction chamber housing 20, in some instances, defines a spherical shape, or, generally, defines an internal profile that is symmetric about the axis of the input shaft 150. Similarly, the rotor 240, in some instances, has a shape defining a symmetric profile about the input shaft 150 axis.

While FIG. 7 shows the bearing assembly 750 integrated with the inlet volute 110, alternatively, the bearing assembly 751 is, in some instances, an external bearing assembly supporting the input shaft 150 with or without the external bearing assembly being coupled to the input volute 110.

While FIGS. 1-8 show the input shaft 150 as being contiguous through the fluid device 100, in some instances the input shaft 150 is a split shaft having two segments configured to be joined by a rotor 240 coupled to a first segment at a first end and a second segment at a second end of the input shaft.

While FIGS. 1-8 show the fluid device as a cavitation generator 100, in some instances the fluid device is a fluid pump. In a fluid pump embodiment, the split casing design of the reactor chamber housing is be similar, however instead of apertures formed into the rotor 240 or stator 860a,b, the rotor and stator include pumping features to increase pressure in the fluid flow with rotation of the rotor. In some instances, the rotor is an impeller. In some instances, the fluid device is a multi-stage pump having multiple sets of impellers or rotors either in a single chamber or in multiple chambers. The chambers being designed such that each impeller increases the pressure of the water by some magnitude. In some instances, the stators direct the flow from one impeller to the next until the fluid flow reaches the outlet 131.

While FIGS. 1-8 show the casings 120a,b of the reaction chamber 20 spanning the length of the reaction chamber 20, in some instances, one or more of the casings span only a partial length of the reaction chamber housing 20, and removal of one or more of the casings creates an opening in the reaction chamber housing sufficient to remove the rotor 240, by being sized and shape to accept one of the rotor segments though the opening after disconnecting the rotor segment from the input shaft 150 and the other rotor segment.

While FIGS. 1-8 shown the rotor 240 and reaction chamber housing 20 as constructed from rotor segments and casings defining opposing halves of their corresponding parent structures 240, 20, one skilled in the art will appreciate that both the reaction chamber housing 20 and rotor 240 are, in some instances, constructed from a plurality of segments.

While FIGS. 1-8 have shown the fluid device as a cavitation generator, in some instances the fluid device is a mixer. In some instances, the fluid device is a system acting on a fluid with a rotational component contained in a housing and configured to pass a flow of the fluid through or across the rotational component.

A number of implementations have been described. Nevertheless, it will be understood that various modifications may be made. Accordingly, other implementations are within the scope of the following claims.

What is claimed is:

1. A split casing fluid device, the split casing fluid device comprising:
a reaction chamber housing comprising:
a first casing comprising a first portion of a stator, and
a second casing comprising a second portion of the stator, the first and second casings defining the reaction chamber housing;
a rotor rotatably mounted inside the stator and defining a length along a longitudinal axis of rotation, the rotor comprising an exterior surface having a plurality of fluid-interacting features, the rotor exterior surface and the stator defining a fluid passageway therebetween;
a fluid inlet into the reaction chamber housing, the fluid inlet in fluid communication with the fluid passageway; and
a fluid outlet from the reaction chamber housing, the fluid outlet in fluid communication with the fluid passageway,
wherein removal of one or more of the casings defines an opening in the reaction chamber housing sized and shaped to allow passing the rotor through the opening.

2. The split casing fluid device of claim 1, wherein the rotor defines a minimum diameter, and wherein each casing of the reaction chamber housing spans at least the length of the rotor, and wherein at least one of the first and second casing comprises an inner surface defining a width greater than the minimum diameter of the rotor respect to a plane normal to the longitudinal axis of the rotor.

3. The split casing fluid device of claim 1, wherein the first and second casings defining opposing halves of the reaction chamber housing.

4. The split casing fluid device of claim 1, wherein the rotor comprises first and second rotor segments removeably coupled together, the first and second rotor segments each spanning the length of the rotor.

5. The split casing fluid device of claim 4, wherein the first and second rotor segments define opposing halves of the rotor.

6. The split casing fluid device of claim 1, wherein the rotor includes first and second ends each defining a cone shaped surface varying the width of the fluid passageway along the flow cone.

7. The split casing fluid device of claim 1, wherein the first portion of the stator is formed on an interior surface of the first casing and the second portion of the stator is formed on an interior surface of the second casing.

8. The split casing fluid device of claim 1, wherein the first portion of the stator is a first stator sleeve and wherein the second portion of the stator is a second stator sleeve, the first and second stator sleeves removeably nest within an inner surface of the respective first and second casings.

9. The split casing fluid device of claim 1, wherein the rotor defines an interior rotor volume in fluid communication with the fluid inlet, and wherein the fluid-interacting features are thru-holes between the interior rotor volume and the fluid passageway

10. The split casing fluid device of claim 1, further including:
an input shaft having first and second ends, the rotor coupled to the input shaft and the input shaft adapted to enable rotation of the rotor in the reaction chamber housing and transfer torque to the rotor;
an inlet assembly comprising a first bearing coupled with the first end of the input shaft; and
an outlet assembly comprising a second bearing coupled with the second end of the input shaft.

11. The split casing fluid device of claim 10, wherein the first and second casings each comprise opposing first and second ends, and wherein the first ends of the first and second casings are removeably coupled to the inlet assembly, and wherein the second ends of the first and second casing are removeably coupled to the outlet assembly.

12. The split casing fluid device of claim 10, wherein the inlet assembly defines a first inner passageway in fluid communication with the fluid passageway and the outlet assembly defines a second inner passageway in fluid communication with the fluid passageway, the input shaft passing through the first and inner passageways.

13. The split casing fluid device of claim 10, wherein the rotor comprises first and second rotor segments removeably coupled together, the first and second rotor segments each spanning the length of the rotor and wherein the input shaft includes an axial lock key adapted to maintain an axial location of the rotor segments on the input shaft.

14. The split casing fluid device of claim 10, wherein the inlet assembly comprises a first external bearing assembly having the first bearing, and wherein the outlet assembly comprises a second external bearing assembly having the second bearing, and wherein the first and second external bearing assemblies position the first and second bearing outside of the first and second inner passageways.

15. The split casing fluid device of claim 1, wherein the split casing fluid device is a split casing cavitation generator, and wherein the plurality of fluid-interacting features comprises a plurality of cavitation-inducing features, and wherein the fluid outlet is a heated fluid outlet.

16. The split casing cavitation generator of claim 15, wherein the stator comprises an inner surface defining a first plurality of apertures and wherein the plurality of cavitation-inducing features comprises a second plurality of apertures.

17. The split casing fluid device of claim 1, wherein the split casing fluid device is a split casing pump, and wherein the plurality of fluid-interacting features comprises a plurality of pumping features.

18. A method of servicing a split casing fluid device, the method comprising:
given a reaction chamber housing comprising a first casing and a second casing and a rotor rotatably mounted inside the reaction chamber housing;
releasing the first casing from the second casings;
removing one of the first and second casings from the reaction chamber housing, the removing one of the first and second casings creating an opening in the reaction chamber housing sized and shaped to enable the rotor to pass though the opening.

19. The method of claim 18, further comprising passing the rotor though the opening.
